(19) United States
(12) Patent Application Publication
(10) Pub. No.: US 2010/0114815 A1
(43) Pub. Date: May 6, 2010

(54) METHODS AND APPARATUS TO PERFORM DATABASE RECORD REPORTING USING A WEB BROWSER INTERFACE

(76) Inventors: Alexander Longin, Vernon Hills, IL (US); Vladislava Borisova, Skokie, IL (US); Stanislav Keselman, Wheeling, IL (US)

Correspondence Address: AT&T Legal Department - HFZ;ATTN. Patent Docketing, One AT&T Way, Room 2A-207, Bedminstor, NJ, 07921, US

(21) Appl. No.: 12/254,703

(22) Filed: Oct. 20, 2008

(51) Int. Cl. G06F 17/30

(52) U.S. Cl. 707/603; 707/E17.061

(57) ABSTRACT

Methods and apparatus to perform database record reporting using a web browser interface are disclosed. An example method disclosed herein comprises pre-calculating first summary data and a first number of data records expected to be returned for a first reporting query, the first reporting query designated as a summary reporting query, the first summary data determined from a first set of data records obtained in response to querying a database based on first search criteria included in the first reporting query, providing the first reporting data and the first number of data records without querying the database in response to an invocation of the first reporting query, and querying the database to identify a second set of data records satisfying the first search criteria in response to an invocation of a second reporting query, the second reporting query designated as a detailed reporting query.

### FIELD OF THE DISCLOSURE

This disclosure relates generally to database reporting and, more particularly, to methods and apparatus to perform database record reporting using a web browser interface.

### BACKGROUND

Databases for storing data records have widespread applicability and are employed in any number of data processing applications. Most systems for managing databases include tools to facilitate reporting of data records satisfying certain specified search criteria. For example, such database management systems may provide one or more reporting tools (or applications) allowing a user to specify search criteria to be used for record reporting. Then, in response an invocation of a query including the specified search criteria, the one or more reporting tools identify any data record(s) in the database satisfying the specified search criteria.

Typically, the conventional record reporting tools implemented by these database management systems return a first (or summary) subset of the data records satisfying the specified search criteria, along with an indication of the total number of records expected to satisfy the specified search criteria. Depending on the expected total number of records returned for a query, the user may then perform a trial-and-error procedure involving refining the search criteria and invoking subsequent queries to yield a manageable number of data records satisfying the search criteria. However, after invoking each query in such a trial-and-error procedure, the user must wait for a search of the database to be performed and for the data record(s) satisfying the specified search criteria to be identified.

### BRIEF DESCRIPTION OF THE DRAWINGS

FIG. 1 is a block diagram of an example database reporting system capable of implementing the methods and apparatus described herein.

FIG. 2 is a block diagram of an example record reporting processor that may be used to implement the example database reporting system of FIG. 1.

FIG. 3 illustrates an example plurality of reporting queries configured by the example record reporting processor of FIG. 2 to form a reporting path hierarchy for use with the example database reporting system of FIG. 1.

FIG. 4 is a flowchart representative of example machine readable instructions that may be executed to implement the example record reporting processor of FIG. 2.

FIG. 5 is a flowchart representative of example machine readable instructions to perform an initialization procedure that may be used to implement the example machine readable instructions of FIG. 4 and/or executed to implement initialization phase processing in the example record reporting processor of FIG. 2

FIG. 6 is a flowchart representative of example machine readable instructions to perform a pre-calculation procedure that may be used to implement the example machine readable instructions of FIG. 4 and/or executed to implement pre-calculation processing in the example record reporting processor of FIG. 2

FIG. 7 is a flowchart representative of example machine readable instructions to perform a report generation procedure that may be used to implement the example machine readable instructions of FIG. 4 and/or executed to implement report generation processing in the example record reporting processor of FIG. 2.

FIG. 8 is a flowchart representative of example machine readable instructions to perform an example record retrieval procedure that may be used to implement the example machine readable instructions of FIG. 7 and/or executed to implement record retrieval processing in the example record reporting processor of FIG. 2.

FIG. 9 is a block diagram of an example computer that may execute the example machine readable instructions of FIGS. 4-7 and/or 8 to implement the example record reporting processor of FIG. 2.

### DETAILED DESCRIPTION

Methods and apparatus to perform database record reporting using a web browser interface are disclosed herein. In an example database reporting system described herein, multiple reporting queries are specified and configured to form a reporting path hierarchy. Reporting queries along a particular reporting path include a common set of search criteria, with each reporting query at a lower level of the path hierarchy including additional search criteria along with the common set of search criteria. Also, each reporting query is designated as either a summary reporting query or a detailed reporting query. A detailed reporting query operates to return all data records from a database that are identified as satisfying its specified search criteria. In contrast, a summary reporting query operates to return a short summary of the data records expected to satisfy the search criteria, along with a number of data records expected to satisfy the search criteria. Detailed and summary reporting queries may be linked or otherwise associated (such as by including the same search criteria), for example, to allow invocation of a summary query to indicate expected query results, followed by invocation of a corresponding detailed reporting query to return the actual data records satisfying the specified search criteria.

Additionally, the example database reporting system performs a pre-calculation procedure at specified pre-calculation intervals to determine the summary data and expected number of data records to be returned for each designated summary reporting query in the plurality of reporting queries. In an example implementation, such pre-calculation of the summary data and expected number of data records corresponding to each designated summary reporting query is performed automatically by the example database reporting system without any user intervention. For example, during an iteration of the pre-calculation procedure, the example database reporting system may cycle through the summary reporting queries and perform a database query for each summary reporting query using the search criteria included in that particular summary reporting query. By performing such a pre-calculation procedure, when a particular summary reporting query having certain search criteria is invoked by a user, the example database reporting system can return the corresponding summary data and number of data records expected to satisfy that search criteria (if subsequently used to query the database) almost immediately without needing to wait for a database search to be performed.

Furthermore, the example database reporting system utilizes profiles capable of being associated with one or more search queries. In an example implementation, each profile includes one or more structured query language (SQL) clause templates to be populated by at least some of the search criteria included in an associated search query. Additionally, at least some of the profiles include one or more thresholds to associate an allowable size of a set of returned data records with a respective record reporting format. For example, one threshold may cause a set of data records identified for a particular invoked detailed search query to be returned in a first format if the set size does not exceed the first threshold, whereas another threshold may cause the set of data records to be returned in a second format if the set size exceeds the first threshold but not the second threshold. In an example implementation, the decision regarding which format to use is performed automatically by the example database reporting system without requiring any user intervention. Such a use of record reporting thresholds can help ensure accurate and successful reporting of data records to a user's client device.

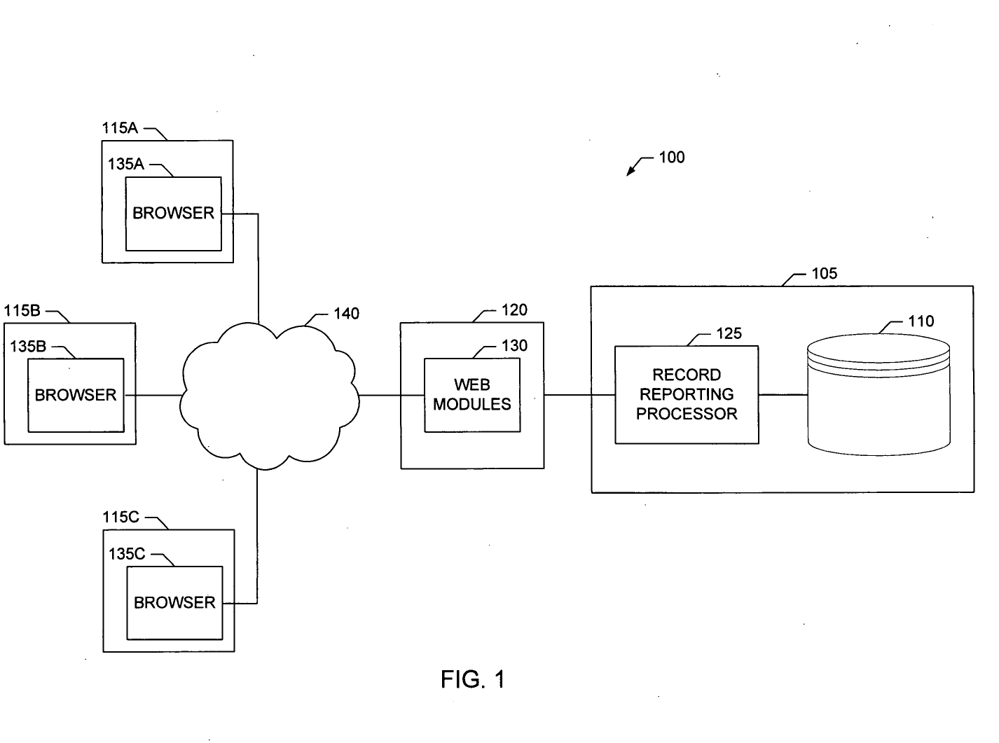

Turning to the figures, a block diagram of an example database reporting system 100 capable of implementing the methods and apparatus described herein is illustrated in FIG. 1. The example database reporting system 100 includes a database server 105 implementing one or more databases 110. The example database server 105 may be implemented using any type of server and/or computing technology, such as one or more workstations, personal computers, personal digital assistants (PDAs), mobile telephones, etc. In the illustrated example, the database server 105 implements, at least in part, an SQL compatible database management system to manage the example database 110, although any other type of database management system may alternatively be implemented. Furthermore, although one database server 105 is shown in the illustrated example of FIG. 1, the example database reporting system 100 can readily adapted to support any number of database servers.

The example database 110 may be any type of database, data storage facility, etc. In the illustrated example, the database 110 is configured to be an SQL-compatible relational database. However, any other database model or other data storage configuration may alternatively or additionally be used to implement the example database 110. In the illustrated example, the database 110 is configured to store data in one or more data records, with each record formatted to have one or more fields. Although the example database 110 is assumed to store data in one or more fields of one or more data records, the example database reporting system 100 can be readily adapted to support any other type of data storage arrangement.

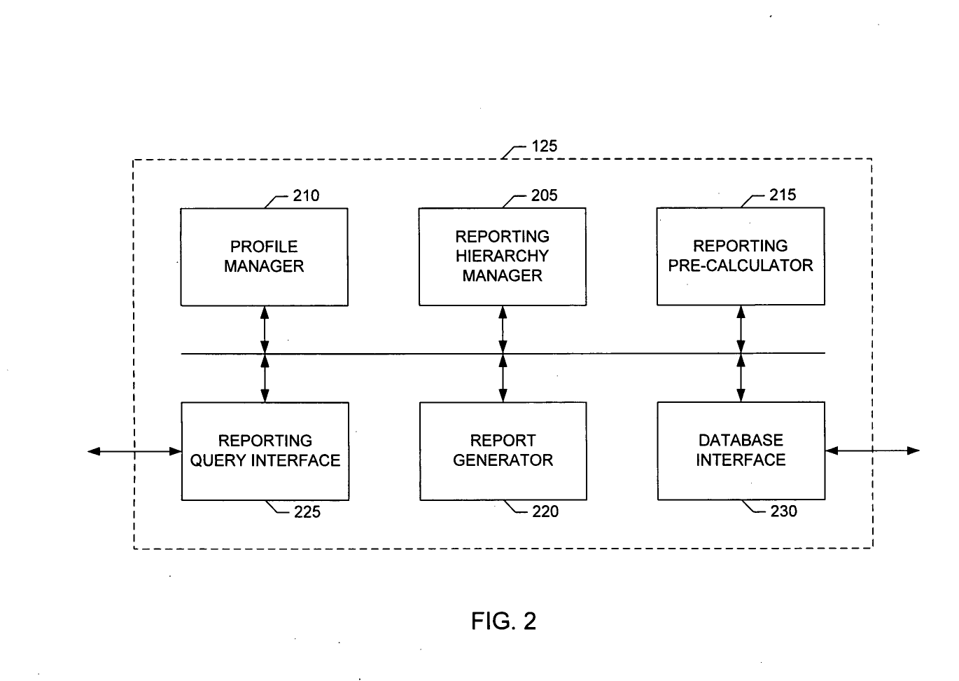

To allow one or more users to access data stored in the example database 110, the example database reporting system 100 includes one or more client devices 115A, 115B and 115C, as well as a client server 120. In the illustrated example, the client server 120 implements a web server 120 to provide a web-based interface to a record reporting processor 125 implemented by and/or associated with the example database server 105. The example record reporting processor 125 implements multiple reporting queries that may be used to query the example database 110, identify those data records matching specified search criteria included in the reporting queries and return the identified data records to the example web server 120. Additionally, the example record reporting processor 125 configures the multiple reporting queries to form a reporting path hierarchy accessible via the example web server 120. Furthermore, the example record reporting processor 125 designates each reporting query as either a summary reporting query or a detailed reporting query. As described above, a detailed reporting query is configured to return all data records identified in the example database as satisfying the query's specified search criteria, whereas a summary reporting query is configured to return summary data representative of the data records expected to satisfy the query's search criteria, as well as a number of data records expected to satisfy the search criteria. An example implementation of the record reporting processor 125 is illustrated in FIG. 2 and discussed in greater detail below.

The example web server 120 may be implemented using any type of web server technology operating with any type of server and/or computing technology, such as one or more workstations, personal computers, personal digital assistants (PDAs), mobile telephones, etc. Additionally, the example web server 120 includes one or more web modules 130 to interface with the example record reporting processor 125. For example, the web modules 130 may include one or more web pages and/or web server code configured to (1) access the multiple reporting queries and reporting path hierarchy implemented by the example record reporting processor 125, (2) cause any of the multiple queries to be invoked by the example record reporting processor 125, (3) accept data record(s) and/or other summary data (discussed in greater detail below) returned by the example record reporting processor 125 in response to an invoked query, (4) provide the accepted data record(s) and/or other summary data for presentation to and/or downloading by the user(s) accessing the example web server 120, etc. Although one web server 120 is shown in the illustrated example of FIG. 1, the example database reporting system 100 can be readily adapted to support any number of web servers.

The example client devices 115A, 115B and 115C may be implemented by any type of client device, such as one or more workstations, personal computers, personal digital assistants (PDAs), mobile telephones, etc. Additionally, because the example client server 120 implements an example web server 120, each client device 115A, 115B and 115C includes a respective web browser 135A, 135B and 135C. The example web browsers 135A, 135B and 135C may be implemented using any type of web browser capable of accessing the example web server 120, presenting and/or downloading data record(s) and/or other summary data (discussed in greater detail below) provided by the example web server 120, etc. Although three client devices 115A, 115B and 115C are shown in the illustrated example of FIG. 1, the example database reporting system 100 can be readily adapted to support any number of client devices.

In the illustrated example, the one or more client devices 115A, 115B and 115C access the web server 120 using a network 140. The example network 140 may be implemented by any type of network, such as a local area network (LAN), wide area network (WAN), wireless LAN and/or WAN, cellular network, the Internet, etc., and/or any combination thereof.

In FIG. 1, the example database reporting system 100 is illustrated as including an example record reporting processor 125 implemented by an example database server 105 and accessed via a web interface implemented by the example web browser 120 and the example client devices 115A, 115B and 115C. However, other implementations of the example database reporting system 100 are also contemplated herein. For example, the database reporting system 100 may utilize a separate server to implement the example record reporting processor 125. In another example, the example database reporting system 100 could be implemented as an integrated, stand-alone solution including, for example, the record reporting processor 125 and a user interface operating in a single device.

A block diagram of an example implementation of the record reporting processor 125 of FIG. 1 is illustrated in FIG. 2. In the illustrated example of FIG. 2, the example record reporting processor 125 includes a reporting hierarchy manager 205 to (1) specify multiple reporting queries to be used to query the example database 110 and (2) configure the multiple reporting queries to form a reporting path hierarchy. In the illustrated example, the reporting hierarchy manager 205 implements an administrative interface to allow search criteria to be specified for each of the multiple reporting queries. For example, the search criteria may include one or more database field values, one or more database field value ranges and/or any other criteria that must be matched by a data record included the database 110 for the data record to satisfy the search criteria.

Additionally, the multiple reporting queries may be configured to form a reporting path hierarchy using the administrative interface implemented by the example reporting hierarchy manager 205. As described above, reporting queries configured to be along a particular reporting path all include a common set of search criteria. In an example implementation, the common set of search criteria is specified in the reporting query at the highest level in the reporting path. Then, additional search criteria are included in each reporting query located at each successively lower level of the reporting path. As such, a reporting query at a particular level of the reporting path will include all of the search criteria included in another reporting query located at the next higher level in the reporting path. By utilizing the reporting path hierarchy, queries of the database may be performed along a reporting path such that each successive reporting query provides a “drill-down,” or refinement, of the search criteria corresponding to a preceding reporting query.

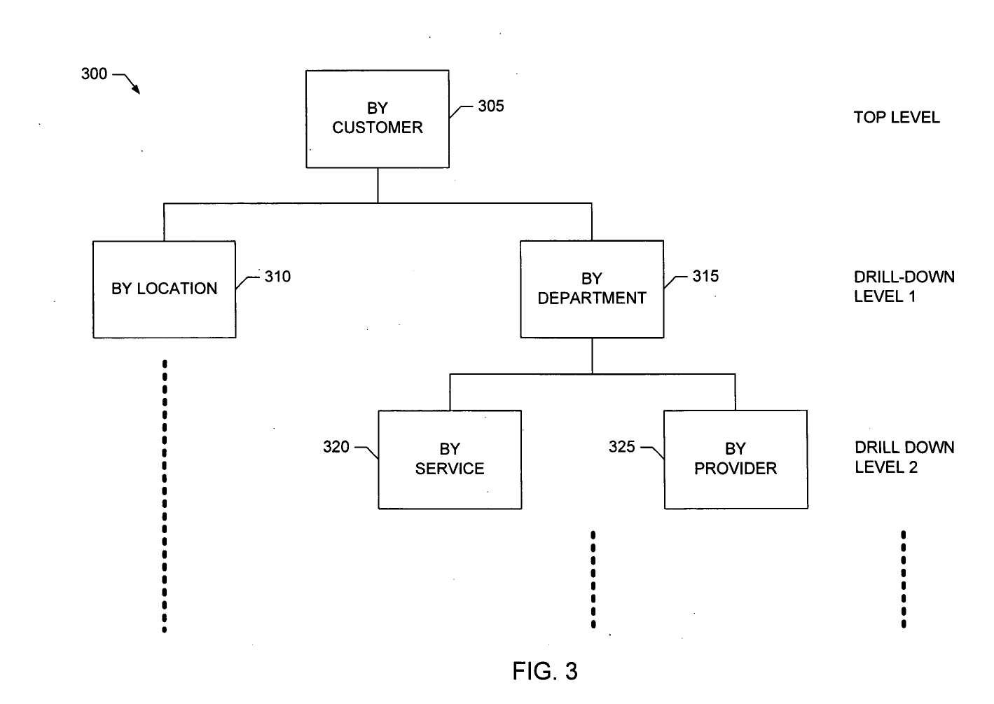

To further illustrate operation of the example reporting hierarchy manager 205, an example reporting path hierarchy 300 that may be implemented by the example reporting hierarchy manager 205 is illustrated in FIG. 3. In the illustrated example, a customer query 305 is at a top level of the reporting path hierarchy 300. The example customer query 305 specifies search criteria to be used to match data records in the example database 110 corresponding to a specified customer name. In an example implementation, the customer query 305 may be implemented by multiple customer queries, each specifying search criteria corresponding to a particular customer name. Additionally or alternatively, the example customer query 305 may be implemented to include a particular customer name as an input argument. In either case, the example customer query 305 can be invoked to cause the example database 110 to be queried using the specified customer name search criteria to return data records satisfying the specified customer name.

The example reporting path hierarchy 300 also includes a location query 310 at a first drill-down level along a first reporting path originating from the example customer query 305. The example location query 310 includes the search criteria specified in the example customer query 305 to be used to match data records in the example database 110 corresponding to a specified customer name. Additionally, the example location query 310 includes search criteria further requiring that any matched data records also correspond to a specified location. Like the example customer query 305, the example location query 310 may be implemented by multiple location queries, each specifying search criteria corresponding to a particular location. Additionally or alternatively, the example location query 310 may be implemented to include a particular location as an input argument.

Additionally, the example reporting path hierarchy 300 includes a department query 315 at a first drill-down level along a second reporting path originating from the example customer query 305. The example department query 315 includes the search criteria specified in the example customer query 305 to be used to match data records in the example database 110 corresponding to a specified customer name. Additionally, the example department query 315 includes search criteria further requiring that any matched data records also correspond to a specified department. Like the example customer query 305, the example department query 315 may be implemented by multiple department queries, each specifying search criteria corresponding to a particular department. Additionally or alternatively, the example department query 315 may be implemented to include a particular department as an input argument.

Continuing along the second reporting path originating from the example customer query 305, the example reporting path hierarchy 300 further includes a service query 320 and a provider query 325 each at a second drill-down level along respective first and second reporting paths originating from the example department query 315. The example service query 320 and the example provider query 325 each includes the search criteria specified in the example customer query 305 and the example department query 315 to be used to match data records in the example database 110 corresponding to a specified customer name and a specified department. Additionally, the example service query 320 includes search criteria further requiring that any matched data records also correspond to a specified service. Likewise, the example provider query 325 includes search criteria further requiring that any matched data records also correspond to a specified provider. Similar to the other reporting queries, the example service query 320 may be implemented by multiple service queries, each specifying search criteria corresponding to a particular service, and the example provider query 325 may be implemented by multiple provider queries, each specifying search criteria corresponding to a particular provider. Additionally or alternatively, the example service query 320 and/or the example provider query 325 may be implemented to include a particular service and/or provider, respectively, as an input argument.

Returning to FIG. 2, the example reporting hierarchy manager 205 also allows each reporting query to be designated as either a summary reporting query or a detailed reporting query. As described above, a detailed reporting query operates to return all data records from the example database 110 that are identified as satisfying the detailed reporting query's specified search criteria. In contrast, a summary reporting query operates to return summary data providing a short summary of the data records expected to satisfy the summary reporting record's search criteria. For example, the summary data could include a one line, a one page, or some other short listing of data record values that matched the database field values specified in the search criteria included in the particular summary reporting query. Additionally or alternatively, the summary data could include one or more statistical representations of a range of data record values, such as one or more of a maximum value, a minimum value, an average value, etc., that matched the database field value ranges specified in the search criteria included in the particular summary reporting query. In the illustrated example, each summary reporting query also operates to return a number of data records expected to satisfy the summary reporting query's search criteria. Such a returned expected number of data records allows a user to determine whether the returned expected number of data records is acceptable or whether to refine (or drill-down) the search to one or more successive reporting path levels to reduce the number of reported data records.

Additionally, the example record reporting processor 125 includes a profile manager 210 to specify a set of profiles and to associate a profile with one or more reporting queries. In an example implementation, each profile includes one or more SQL clause templates to be populated by at least some of the search criteria included in an associated reporting query. As such, a particular reporting query invoked in combination with its associated profile realizes one or more SQL clauses that may be used to query the example database 110. Example SQL clause templates for use with an example profile include: (1) SELECT clause fragments, (2) FROM clause fragments, (3) WHERE clause fragments, (4) GROUP BY clause fragments, (5) ORDER BY clause fragments, etc. In such an example implementation, the predicate(s) for each SQL clause fragment (or template) included in a profile is(are) derived from the search criteria included in the invoked reporting query that has been associated with the profile.

In an example implementation, one or more of the profiles specified by the example profile manager 210 also include one or more thresholds to be used to determine which reporting format to use to return a set of matching data records from the example database 110 in response to invocation of a reporting query. In an example implementation, the threshold(s) allow reporting formats to be automatically selected based on the size of the set of matching data records. In such an example, the first reporting format may be automatically selected when the size of the set of matching data records does not exceed the first threshold, whereas the second reporting format may be automatically selected when the size of the set of matching data records exceeds the first threshold but does not exceed the second threshold, and so on. Furthermore, a threshold may be included in a profile to specify a maximum size of the set of matching data records, which may be used to prohibit reporting a set of matching data records whose size exceeds such a threshold.

As an illustrative example, a first threshold may be used to specify a first set size for which data records are to be provided in hypertext markup language (HTML) format for presentation in a user's web browser (such as one of the example browsers 135A, 135B or 135C). Additionally, a second threshold may be used to specify a second set size for which data records are to be provided in fixed length text (TXT) format for presentation in the user's web browser. Still further, a third threshold may be used to specify a third set size for which data records are to be provided in tab delimited format for file downloading (such as in a zipped file) to the user's client device (such as one of the example client devices 115A, 115B or 115C). In such an example, sets of matching data records whose sizes exceed the third threshold are deemed to exceed the configured reporting capabilities of the example record reporting processor 125 and, thus, are not reported to the user.

The profiles specified by the example profile manager 210 may also include other attributes and details used to determine how the results of reporting queries are to be provided and presented to the user. Examples of such attributes and details include a specified report name, database field names to be presented, formatting information, etc. Additionally or alternatively, in the case of an example profile to be associated with a summary reporting query, such an example profile may include one or more summary reporting SQL clause templates (or fragments) to used to determine the summary data and/or expected number of data records corresponding to the particular summary reporting query. Furthermore, the profiles may also include a summary indicator to indicate whether summary data or actual data records are to be provided to the user in response to an invocation of an associated reporting query.

The example record reporting processor 125 of FIG. 2 also includes a reporting pre-calculator 215. The example reporting pre-calculator 215 is configured to perform a pre-calculation procedure at specified pre-calculation intervals to determine (or pre-calculate) the summary data and expected number of data records to be returned for each reporting query designated by the example reporting hierarchy manager 205 as a summary reporting query. In an example implementation, the example reporting pre-calculator 215 pre-calculates and stores the summary data and expected number of data records corresponding to each designated summary reporting query automatically without any user intervention. For example, after expiration of the most recent pre-calculation interval, the example reporting pre-calculator 215 may cycle through the designated summary reporting queries and perform a query of the example database 110 for each summary reporting query using the search criteria included in that particular summary reporting query. The example reporting pre-calculator 215 may determine the query to be performed by accessing the profile associated with the particular summary reporting query and populating the profile's SQL clause templates with the summary reporting query's search criteria.

At some later time, the example pre-calculator 215 may process the set of data records returned by the example database 110 to determine the summary data and count the expected number of data records corresponding to the particular summary reporting query. The example pre-calculator 215 may then update or replace any previously stored summary data or expected number of data records with the summary data and expected number of data records determined during the current iteration of the pre-calculation procedure. This updated or replaced pre-calculated information will then be provided instead of the previously stored pre-calculated information in response to a subsequent invocation of the particular reporting query.

The example record reporting processor 125 of FIG. 2 further includes a report generator 220. The example report generator 220 operates to invoke a selected reporting query from the multiple reporting queries managed by the example reporting hierarchy manager 205. In the illustrated example, the report generator 220 is configured to accept a reporting query selection from a user via a reporting query interface 225. The example report generator 220 then retrieves the profile associated with the selected reporting query as specified by the example profile manager 210. If the selected reporting query is a summary reporting query, the example report generator 220 uses the summary reporting SQL clause template(s) included in the retrieved profile to provide the stored summary data and expected number of data records pre-calculated by the example reporting pre-calculator 215 for the selected summary reporting query.

Additionally or alternatively, the example report generator 220 may compare the expected number of data records to the one or more reporting format thresholds included in the retrieved profile. Then, based on the comparison, the example report generator 220 may indicate that the provided summary data and/or expected number of data records are to be presented in a certain manner, such as using a certain font, color, etc., according to which data reporting threshold was met. In this way, the summary data and/or expected number of data records can be presented to the user in a manner forecasting how the corresponding actual data records would be reported if a detailed reporting query corresponding to the particular summary reporting query was subsequently invoked. Because the same search criteria is used for both the particular summary reporting query and the corresponding detailed reporting query, the set of data records used to determine the summary data and the expected number of data records for the summary reporting query should be substantially similar to the set of data records identified for the detailed reporting query, unless the example database 110 is modified between the most recent pre-calculation iteration and invocation of the detailed reporting query. As such, the presented summary data and the expected number of data records can provide an accurate forecast of the size of the data records that will be returned for a corresponding detailed reporting query.

As an illustrative example, a presentation of the summary data and/or expected number of data records in a first font and/or first color could indicate that a corresponding actual set of data records would be provided according to a first reporting format (such as an HTML reporting format), whereas a presentation in a second font and/or second color could indicate that the corresponding actual set of data records would be provided according to a second reporting format (such as a fixed length or tab delimited text format). As noted above, by using pre-calculated reporting results, when a particular summary reporting query having certain search criteria is invoked by a user, the example report generator 220 can return the corresponding summary data and number of data records expected to satisfy that search criteria via the example reporting query interface 225 almost immediately without needing to wait for a database search to be performed. In an example implementation

However, if the selected reporting query is a detailed reporting query, the example report generator 220 populates the SQL clause template(s) included in the retrieved profile with the search criteria included in the selected reporting query. The example report generator 220 then uses the populated SQL template(s) to query the example database 110 via the example database interface 230. Next, the example report generator 220 receives via the example database interface 230 the set of data records returned by the example database 110 in response to the query. Then, the example report generator 220 compares the size of the set of returned data records to the threshold(s) included in the retrieved profile to determine which reporting format to use to provide the set of returned data records. The example report generator then provides the set of returned data records via the example reporting query interface 225 according to the determine reporting format.

In the illustrated example, the example reporting query interface 225 is configured to implement with a web server, such as the example web server 120 of FIG. 1. Also, the example database interface 230 is configured to interface with an SQL-compatible relational database such as the example database 110 of the FIG. 1. However, the example reporting query interface 225 and/or the example database interface 230 may be adapted to support other interface types depending on the application in which the example record reporting processor 125 of FIG. 2 is to be employed.

While an example manner of implementing the record reporting processor 125 of FIG. 1 has been illustrated in FIG. 2, one or more of the elements, processes and/or devices illustrated in FIG. 2 may be combined, divided, re-arranged, omitted, eliminated and/or implemented in any other way. Further, the example reporting hierarchy manager 205, the example profile manager 210, the example reporting pre-calculator 215, the example report generator 220, the example reporting query interface 225, the example database interface 230 and/or, more generally, the example record reporting processor 125 of FIG. 2 may be implemented by hardware, software, firmware and/or any combination of hardware, software and/or firmware. Thus, for example, any of the example reporting hierarchy manager 205, the example profile manager 210, the example reporting pre-calculator 215, the example report generator 220, the example reporting query interface 225, the example database interface 230 and/or, more generally, the example record reporting processor 125 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example record reporting processor 125, the example reporting hierarchy manager 205, the example profile manager 210, the example reporting pre-calculator 215, the example report generator 220, the example reporting query interface 225 and/or the example database interface 230 are hereby expressly defined to include a tangible medium such as a memory, digital versatile disk (DVD), compact disk (CD), etc., storing such software and/or firmware. Further still, the example record reporting processor 125 of FIG. 2 may include one or more elements, processes and/or devices in addition to, or instead of, those illustrated in FIG. 2, and/or may include more than one of any or all of the illustrated elements, processes and devices.

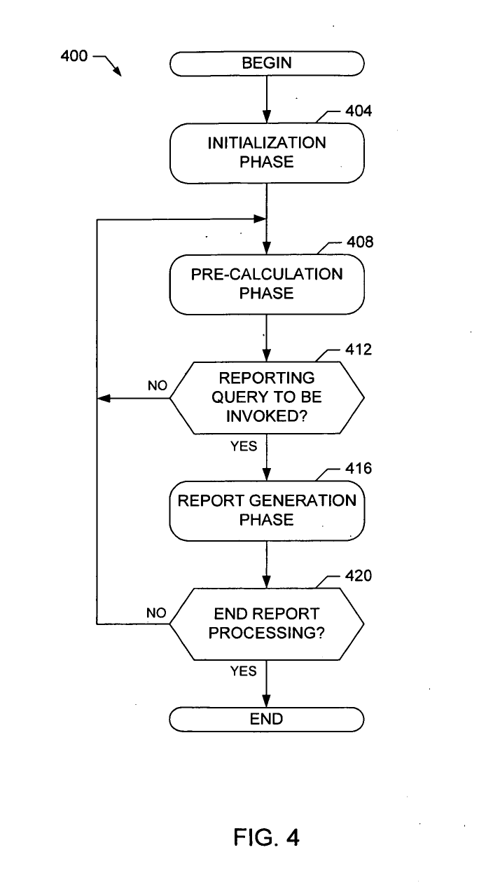

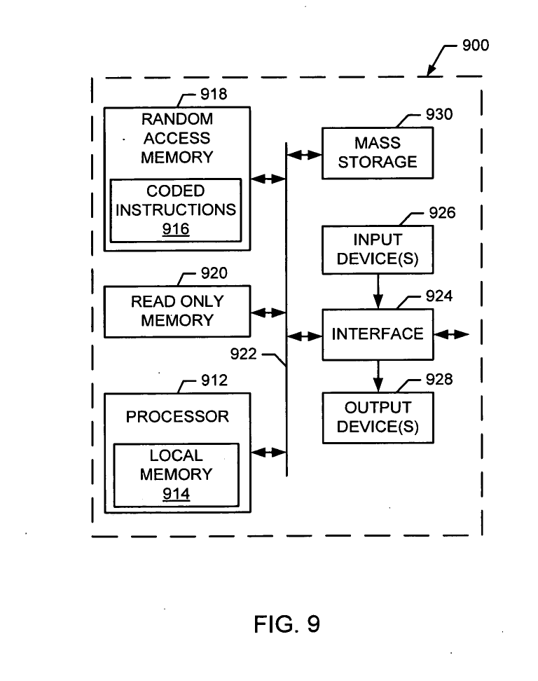

Flowcharts representative of example machine readable instructions that may be executed to implement the example database server 105, the example record reporting processor 125, the example reporting hierarchy manager 205, the example profile manager 210, the example reporting pre-calculator 215, the example report generator 220, the example reporting query interface 225 and/or the example database interface 230 are shown in FIGS. 4-8. In these examples, the machine readable instructions represented by each flowchart may comprise one or more programs for execution by: (a) a processor, such as the processor 912 shown in the example computer 900 discussed below in connection with FIG. 9, (b) a controller, and/or (c) any other suitable device. The one or more programs may be embodied in software stored on a tangible medium such as, for example, a flash memory, a CD-ROM, a floppy disk, a hard drive, a DVD, or a memory associated with the processor 912, but the entire program or programs and/or portions thereof could alternatively be executed by a device other than the processor 912 and/or embodied in firmware or dedicated hardware (e.g., implemented by an application specific integrated circuit (ASIC), a programmable logic device (PLD), a field programmable logic device (FPLD), discrete logic, etc.). For example, any or all of the example database server 105, the example record reporting processor 125, the example reporting hierarchy manager 205, the example profile manager 210, the example reporting pre-calculator 215, the example report generator 220, the example reporting query interface 225 and/or the example database interface 230 could be implemented by any combination of software, hardware, and/or firmware. Also, some or all of the machine readable instructions represented by the flowchart of FIGS. 4-8 may be implemented manually. Further, although the example machine readable instructions are described with reference to the flowcharts illustrated in FIGS. 4-8, many other techniques for implementing the example methods and apparatus described herein may alternatively be used. For example, with reference to the flowcharts illustrated in FIGS. 4-8, the order of execution of the blocks may be changed, and/or some of the blocks described may be changed, eliminated, combined and/or subdivided into multiple blocks.

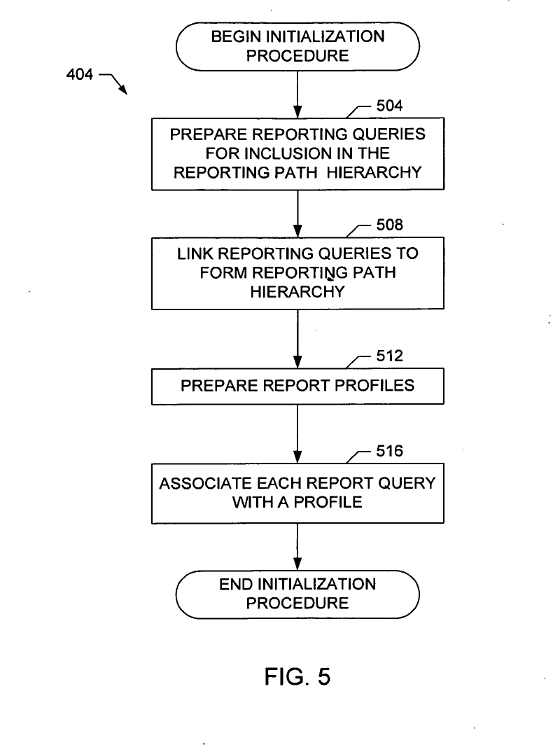

Example machine readable instructions 400 that may be executed to implement the example record reporting processor 125 of FIGS. 1 and/or 2 are represented by the flowchart shown in FIG. 4. The example machine readable instructions 400 may be executed at predetermined intervals, based on an occurrence of a predetermined event, etc., or any combination thereof. With reference to FIG. 2, the example machine readable instructions 400 of FIG. 4 begin execution at block 404 at which the example record reporting processor 125 performs initialization phase processing. For example, at block 404 the example record reporting processor 125 initializes one or more reporting queries, designates reporting queries as either summary or detailed reporting queries, initializes the reporting path hierarchy, initializes one or more profiles to be associated with the one or more reporting queries, etc. Example machine readable instructions that may be used to implement the processing at block 404 are illustrated in FIG. 5 and discussed in greater detail below.

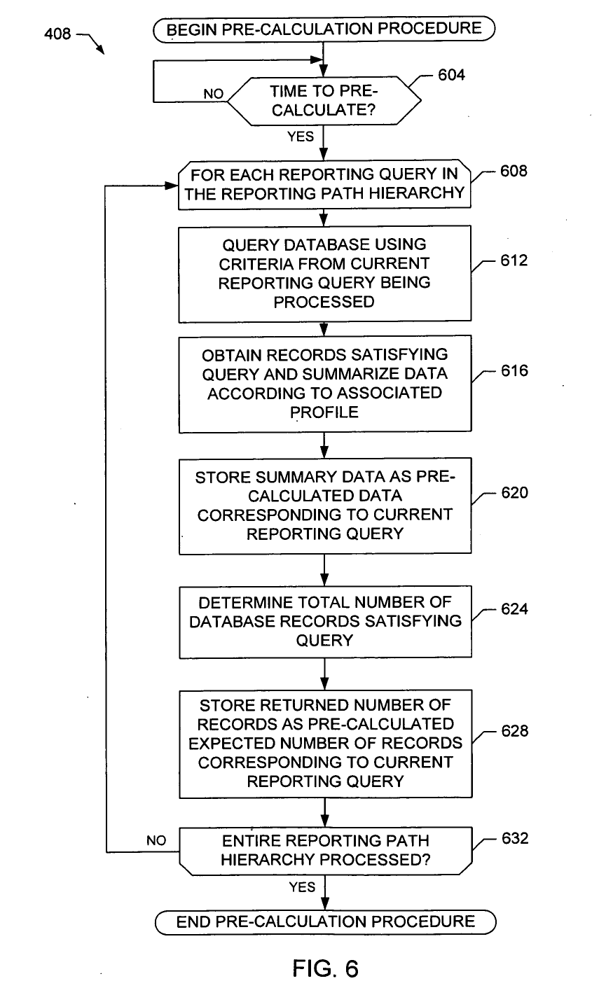

Control next proceeds to block 408 at which the example record reporting processor 125 performs pre-calculation phase processing. For example, at block 408 the example record reporting processor 125 pre-calculates and stores the summary data and the expected number of data records to be returned for each reporting query designated as a summary reporting query. Example machine readable instructions that may be used to implement the processing at block 408 are illustrated in FIG. 6 and discussed in greater detail below.

Next, control proceeds to block 412 at which the example record reporting processor 125 determines whether a reporting query is to be invoked. In an example implementation, at block 412 the reporting query interface 225 included in the example reporting processor 125 is configured to receive commands via the example web server 120 from a user selecting one or more reporting queries to be invoked by the example record reporting processor 125. In such an example implementation, the user accesses the example web server 120 via the example web browser 135A, 135B and/or 135C. In turn, the example web modules 130 present the example reporting path hierarchy implemented by the example reporting processor 125 to the user in a web browser format. The user is then able to select a particular reporting query from the presented reporting path hierarchy to be invoked by the example reporting processor 125.

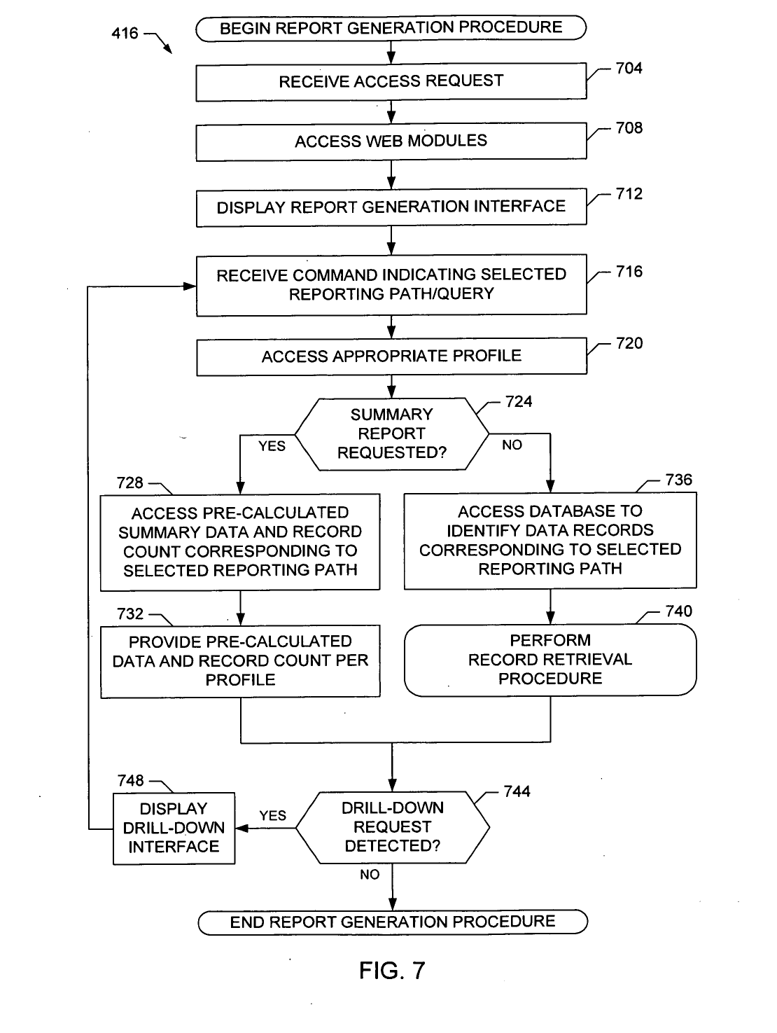

If a reporting query is not to be invoked (block 412), control returns to block 408 at which the example record reporting processor 125 can perform another iteration of pre-calculation phase processing. However, if the reporting query is to be invoked (block 412), control proceeds to block 416 at which the example record reporting processor 125 performs report generation phase processing. In an example implementation, at block 416 the example record reporting processor 125 retrieves the reporting query selected for invocation. If the reporting query is designated as a summary reporting query, the example record reporting processor 125 returns the stored summary data and expected number of data records corresponding to the selected reporting query to the user via the example reporting query interface 225. If, however, the reporting query is designated as a detailed reporting query, the example record reporting processor 125 queries the example database 110 to identify and returns, if appropriate, the data records satisfying/matching the selected reporting query. Example machine readable instructions that may be used to implement the processing at block 412 are illustrated in FIG. 7 and discussed in greater detail below.

Next, control proceeds to block 420 at which the example record reporting processor 125 determines whether report processing is to terminate. For example, at block 420 the example record reporting processor 125 may receive one or more commands via the example reporting query interface 225 and/or an administrative interface implemented by the example reporting query interface 225 indicating that report processing is to be terminated. If report processing is not to be terminated (block 420), control returns to block 408 and blocks subsequent thereto, thereby allowing report processing to continue. However, if report processing is to be terminated (block 420), execution of the example machine readable instructions 400 ends.

In the example machine readable instructions 400 illustrated in FIG. 4, the pre-calculation phase processing (block 408) and the reporting generation phase processing (block 416) occur in a substantially serial manner. However, in another example implementation, pre-calculation phase processing (block 408) is performed in a substantially continuous manner as a background process. In such an implementation, the reporting generation phase processing (block 416) can be performed in parallel with and/or interrupt the pre-calculation phase processing (block 408). Other manners of performing the pre-calculation phase processing (block 408) and the reporting generation phase processing (block 416) are also contemplated herein.

Example machine readable instructions 404 that may be used to implement the initialization phase processing at block 404 of FIG. 4 and/or executed to implement the example record reporting processor 125 of FIGS. 1 and/or 2 are represented by the flowchart shown in FIG. 5. With reference to FIG. 2, the example machine readable instructions 404 of FIG. 5 begin execution at block 504 at which the example reporting hierarchy manager 205 included in the example record reporting processor 125 prepares one or more reporting queries for inclusion in a reporting path hierarchy. For example, at block 504 the example reporting hierarchy manager 205 implements an administrative interface to allow an administrator to specify search criteria to be included in each reporting query. Additionally, at block 504 the example reporting hierarchy manager 205 allows the administrator to designate each reporting query as either a summary reporting query or a detailed reporting query.

Next, control proceeds to block 508 at which the example reporting hierarchy manager 205 included in the example record reporting processor 125 links and/or otherwise configures the reporting queries prepared at block 504 to form a reporting path hierarchy. In an example implementation, the reporting path hierarchy includes one or more reporting paths, with those reporting queries linked/configured to be along a particular reporting path each including a common set of search criteria. Furthermore, a reporting query at a particular level of a reporting path is configured to include all of the search criteria included in another reporting query located at the next higher level in the reporting path, as well as one or more additional search criterion. An example reporting path hierarchy 300 that could be formed by the processing at block 508 is illustrated in FIG. 3 and discussed in greater detail above.

Control next proceeds to block 512 at which the example profile manager 210 included in the example record reporting processor 125 prepares a set of profiles, each of which can be associated with one or more of the reporting queries prepared at block 504. In an example implementation, and as described above, at block 512 the example profile manager 210 specifies one or more SQL clause templates for inclusion in each profile, with the SQL clause template(s) to be populated by at least some of the search criteria included in an associated reporting query. Additionally, in an example implementation, at least some of the profiles prepared by the example profile manager 210 at block 512 include one or more thresholds to be used as described above to determine which reporting format to use to return a set of data records satisfying/matching an associated invoked reporting query.

After the profiles are prepared at block 512, control proceeds to block 516 at which the example profile manager 210 included in the example record reporting processor 125 associates each reporting query prepared at block 504 with a profile prepared at block 512. In an example implementation, the example profile manager 210 can associate one or more reporting queries with a single common profile. After the processing at block 516 completes, execution of the example machine readable instruction 404 ends.

Example machine readable instructions 408 that may be used to implement the pre-calculation phase processing at block 408 of FIG. 4 and/or executed to implement the example record reporting processor 125 of FIGS. 1 and/or 2 are represented by the flowchart shown in FIG. 6. With reference to FIG. 2, the example machine readable instructions 408 of FIG. 6 begin execution at block 604 at which the example reporting pre-calculator 215 included in the example record reporting processor 125 determines whether a specified pre-calculation interval has expired indicating that a next iteration of pre-calculation processing should commence. If the specified pre-calculation interval has not expired (block 604), the example reporting pre-calculator 215 waits until the interval expires. However, if the specified pre-calculation interval has expired (block 604), control proceeds to block 608.

At block 608, the example reporting pre-calculator 215 begins cycling through each designated summary reporting query to pre-calculate and store the summary data and expected number of data records to be returned for each summary reporting query. For a current summary reporting query to be processed, control proceeds to block 612 at which the example reporting pre-calculator 215 queries the example database 110 using the search criteria included in the current summary reporting query undergoing pre-calculation processing. In an example implementation, at block 612 the reporting pre-calculator 215 may form one or more SQL database queries by using the search criteria included in the current summary reporting query to populate the SQL clause fragments included in the profile associated with the current summary reporting query.

Next, at block 616 the example reporting pre-calculator 215 obtains a set of data records from the example database 110 satisfying/matching the query performed at block 616. At block 616, the example reporting pre-calculator 215 also processes (or summarizes) the obtained set of data records to determine summary data corresponding to the current summary reporting query undergoing pre-calculation processing. In an example implementation, at block 616 the reporting pre-calculator 215 uses one or more summary reporting SQL clause template(s) included in the retrieved profile to determine stored summary data from the obtained set of data records satisfying/matching the query performed at block 616. Control then proceeds to block 620 at which the example reporting pre-calculator 215 stores the summary data determined at block 616 as the pre-calculated summary data corresponding to the current summary reporting query undergoing pre-calculation processing.

Next, control proceeds to block 624 at which the example reporting pre-calculator 215 counts or otherwise determines the number of data records included in the set of data records obtained at block 616. Control then proceeds to block 628 at which the example reporting pre-calculator 215 stores the number of data records counted/determined at block 624 as the expected number of data records corresponding to the current summary reporting query undergoing pre-calculation processing. Then, at block 632 the example reporting pre-calculator 215 determine whether all summary reporting queries in the reporting path hierarchy have been processed. If the entire reporting path hierarchy has not been processed (block 632), control returns to block 608 and blocks subsequent thereto at which the example reporting pre-calculator 215 performs pre-calculation processing for a next summary reporting record in the reporting path hierarchy. However, if the entire reporting path hierarchy has been processed (block 632), execution of the example machine readable instructions 408 ends.

Example machine readable instructions 416 that may be used to implement the report generation phase processing at block 416 of FIG. 4 and/or executed to implement the example web server 120 of FIG. 1 and/or the example record reporting processor 125 of FIGS. 1 and/or 2 are represented by the flowchart shown in FIG. 7. With reference to FIGS. 1 and 2, the example machine readable instructions 416 of FIG. 7 begin execution at block 704 at which the example web server 120 receives an access request from one of the example web browsers 135A, 135B or 135C indicating that a user requests access to the example database reporting system 100.

In response to the received access request, control proceeds to block 708 at which the example web server 120 accesses the example web modules 130 implementing the web browser interface to the example record reporting processor 125. Next, at block 712 the example web server 120 utilizes the example web modules 130 to display or otherwise present a report generation interface to the user via one of the example web browsers 135A, 135B or 135C. For example, the report generation interface may present the reporting path hierarchy implemented by the example record reporting processor 125. The report generation interface may also allow the user to select a particular reporting query and/or a particular reporting path to indicate that the reporting query corresponding to the particular reporting path is to be invoked by the example record reporting processor 125. For example, with reference to FIG. 3, the report generation interface could display the example reporting path hierarchy 300 via graphs, menus, etc., and allow the user to select a particular path to cause the correspond reporting query 305, 310, 315, 320 or 325 to be invoked by the example record reporting processor 125.

Next, control proceeds to block 716 when the example reporting query interface 225 included in the example record reporting processor 125 receives a selection command from the example web server 120 indicating that a particular reporting path or a particular reporting query has been selected by the user. Then, at block 720 the example report generator 220 included in the example record reporting processor 125 accepts the reporting query or path selection received at block 716 and retrieves the profile associated with the selected reporting query or the reporting query corresponding to the selected reporting path, respectively. Control then proceeds to block 724 at which the example report generator 220 determines whether the selected reporting query is designated as a summary reporting query.

If the selected reporting query is designated as a summary reporting query (block 724), control proceeds to block 728 at which the example report generator 220 accesses the stored summary data and expected number of records that have been pre-calculated for the selected reporting query. Control then proceeds to block 732 at which the example report generator 220 provides the stored summary data and expected number of records via the example reporting query interface 225 to the example web server 120, which in turn display or otherwise provides this information to the user via one of the example web browsers 135A, 135B or 135C. In an example implementation, at block 732 the example report generator 220 uses one or more summary reporting SQL clause template(s) included in the profile retrieved at block 720 to process and/or provide the stored summary data and expected number of data records corresponding to the selected reporting query.

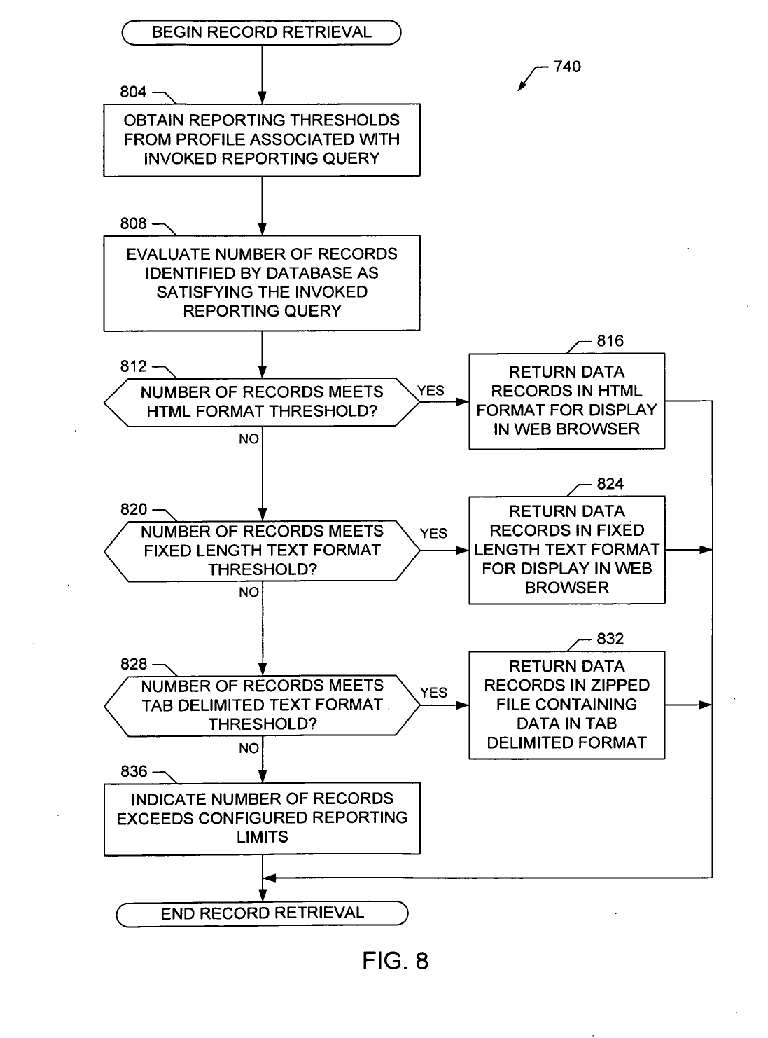

If, however, the selected reporting query is not designated as a summary reporting query (block 724) and, therefore, is designated as a detailed reporting query, control proceeds to block 736 at which the example report generator 220 queries the example database 110 using the search criteria included in the selected reporting query. In response, the data records included in the example database 110 that satisfy the search criteria are identified. In an example implementation, at block 736 the example report generator 220 populates one or more SQL clause templates included in the profile retrieved at block 720 with the search criteria included in the selected reporting query. In such an example implementation, the example report generator 220 then uses the populated SQL template(s) to query the example database 110 via the example database interface 230 to identify the data records satisfying the search criteria. Control then proceeds to block 740 at which the example report generator 220 performs a record retrieval procedure to determine whether and/or how to reporting the identified data records satisfying the search criteria. Example machine readable instructions that may be used to perform the processing at block 740 are illustrated in FIG. 8 and discussed in greater detail below.

After processing at blocks 732 or 740 completes, control proceeds to block 744 at which the example web modules 130 utilized by the example web server 120 determine whether the user has initiated a drill-down request via one of the example web browsers 135A, 135B or 135C. In an example implementation, a drill-down request indicates that the user wishes to refine the search criteria used to query the example database 110 by selecting a reporting query at a lower level along the reporting path that was selected previously. If a drill-down request is detected (block 744), control proceeds to block 748 at which the example web modules 130 utilized by the example web server 120 cause a drill-down interface to be displayed or otherwise presented to the user via one of the example web browsers 135A, 135B or 135C. The displayed/presented drill-down interface allows the user to select a reporting query at a lower level along a previously selected reporting path. Control then returns to block 716 and blocks subsequent thereto at which the next selected reporting query is processed. However, if a drill-down request is not detected (block 744), execution of the example machine readable instructions 416 ends.

Example machine readable instructions 740 that may be used to implement the record retrieval procedure at block 740 of FIG. 7 are represented by the flowchart shown in FIG. 8. With reference to FIG. 2, the example machine readable instructions 740 of FIG. 8 begin execution at block 804 at which the example report generator 220 included in the example record reporting processor 125 obtains one or more reporting thresholds included in a profile associated with an invoked detailed reporting query. Each obtained threshold represents a maximum number of data records (or maximum data record set size) that can be returned using a particular reporting format. In the illustrated example, three reporting thresholds are included in the profile, with the first threshold corresponding to an HTML reporting format, the second threshold corresponding to a fixed length text reporting format and the third threshold corresponding to a tab delimited text format.

Next, control proceeds to block 808 at which the example report generator 220 determines the number of data records (or the size of the set of data records) returned by the example database 110 in response to the invoked detailed reporting query. Control then proceeds to block 812 at which the example report generator 220 determines whether the number of records meets (for example, does not exceed) the first threshold corresponding to the HTML reporting format. If the number of records meets the first threshold (block 812), control proceeds to block 816 at which the example report generator 220 returns the data records via the example reporting query interface 225 in HTML format for display in one of the example web browsers 135A, 135B or 135C. Execution of the example machine readable instructions 740 then ends.

If, however, the number of records does not meet the first threshold (block 812), control proceeds to block 820 at which the example report generator 220 determines whether the number of records meets (for example, does not exceed) the second threshold corresponding to the fixed length text reporting format. If the number of records meets the second threshold (block 820), control proceeds to block 824 at which the example report generator 220 returns the data records via the example reporting query interface 225 in fixed length text format for display in one of the example web browsers 135A, 135B or 135C. Execution of the example machine readable instructions 740 then ends.

If, however, the number of records does not meet the second threshold (block 820), control proceeds to block 828 at which the example report generator 220 determines whether the number of records meets (for example, does not exceed) the third threshold corresponding to the tab delimited text reporting format. If the number of records meets the third threshold (block 828), control proceeds to block 832 at which the example report generator 220 returns the data records via the example reporting query interface 225 in a file (such as a zipped filed) containing the data record in tab delimited text format for downloading to one of the example web browsers 135A, 135B or 135C. Execution of the example machine readable instructions 740 then ends.

However, if the number of records does not meet the third threshold (block 828), control proceeds to block 836. At block 836, the example report generator 220 indicates that the number of data records (or data record set size) exceeds the reporting limited configured to the example record reporting processor 125. Furthermore, at block 836 the example report generator 220 does not return any data records because the reporting limit has been exceeded. Execution of the example machine readable instructions 740 then ends.

FIG. 9 is a block diagram of an example computer 900 capable of implementing the apparatus and methods disclosed herein. The computer 900 can be, for example, a server, a personal computer, a personal digital assistant (PDA), an Internet appliance, a DVD player, a CD player, a digital video recorder, a personal video recorder, a set top box, or any other type of computing device.

The system 900 of the instant example includes a processor 912 such as a general purpose programmable processor. The processor 912 includes a local memory 914, and executes coded instructions 916 present in the local memory 914 and/or in another memory device. The processor 912 may execute, among other things, the machine readable instructions represented in FIGS. 4-8. The processor 912 may be any type of processing unit, such as one or more microprocessors from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 912 is in communication with a main memory including a volatile memory 918 and a non-volatile memory 920 via a bus 922. The volatile memory 918 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 920 may be implemented by flash memory and/or any other desired type of memory device. Access to the main memory 918, 920 is typically controlled by a memory controller (not shown).

The computer 900 also includes an interface circuit 924. The interface circuit 924 may be implemented by any type of interface standard, such as an Ethernet interface, a universal serial bus (USB), and/or a third generation input/output (3GIO) interface.

One or more input devices 926 are connected to the interface circuit 924. The input device(s) 926 permit a user to enter data and commands into the processor 912. The input device(s) can be implemented by, for example, a keyboard, a mouse, a touchscreen, a track-pad, a trackball, an isopoint and/or a voice recognition system.

One or more output devices 928 are also connected to the interface circuit 924. The output devices 928 can be implemented, for example, by display devices (e.g., a liquid crystal display, a cathode ray tube display (CRT)), by a printer and/or by speakers. The interface circuit 924, thus, typically includes a graphics driver card.

The interface circuit 924 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 900 also includes one or more mass storage devices 930 for storing software and data. Examples of such mass storage devices 930 include floppy disk drives, hard drive disks, compact disk drives and digital versatile disk (DVD) drives. The mass storage device 930 may implement the example database 110. Alternatively, the volatile memory 918 may implement the example database 110.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

Additionally, although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to perform record reporting associated with a database comprising a plurality of data records, the method comprising:
pre-calculating first summary data and a first number of data records expected to be returned for a first reporting query in a plurality of possible reporting queries, the first reporting query designated as a summary reporting query, the first summary data determined from a first set of data records obtained in response to querying the database based on first search criteria included in the first reporting query;
providing the first reporting data and the first number of data records in response to an invocation of the first reporting query, the first reporting data and the first number of data records to be provided without querying the database; and
querying the database to identify a second set of data records satisfying the first search criteria in response to an invocation of a second reporting query, the second reporting query designated as a detailed reporting query.

2. A method as defined in claim 1 wherein the first set of data records and the second set of data records are substantially similar unless the database is modified between pre-calculation of the first summary data and a first number of data records and the invocation of the second reporting query.

3. A method as defined in claim 1 wherein the second reporting query at least one of comprises the same first search criteria as the first reporting query or is linked with the first reporting query.

4. A method as defined in claim 1 wherein the plurality of possible reporting queries comprises a plurality of stored reporting queries forming a reporting path hierarchy, and wherein a third reporting query is at a lower level in the reporting path hierarchy and along a reporting path comprising the first reporting query when the third reporting query comprises second search criteria comprising the first search criteria included in the first reporting query and one or more additional search criteria.

5. A method as defined in claim 1 further comprising:
determining when a pre-calculation interval has expired after pre-calculating the first summary data and the first number of data records
after the pre-calculation interval is determined to have expired, pre-calculating second summary data and a second number of data records expected to be returned for the first reporting query, the second summary data determined from a third set of data records obtained in response to querying the database based on the first search criteria included in the first reporting query; and
providing the second reporting data and the second number of data records instead of the first reporting data and the first number of data records in response to a second invocation of the first reporting query, the second reporting data and the second number of data records provided without querying the database.

6. A method as defined in claim 1 further comprising invoking at least one of the first reporting query or a second reporting query via a web browser interface, the web browser implemented by a client device separate from a server implementing the database.

7. A method as defined in claim 1 further comprising:
accessing a profile associated with the first reporting query, the profile comprising a structured query language (SQL) clause template;
populating the SQL clause template using the first search criteria specified in the first reporting query; and
pre-calculating the first summary data and the first number of data records by at least querying the database using the SQL clause template populated using the first search criteria.

8. A method as defined in claim 1 further comprising:
accessing a profile associated with the second reporting query, the profile comprising a first threshold associated with a first reporting format and a second threshold associated with a second reporting format;
providing the identified second set of data records according to the first reporting format when a size of the second set of data records does not exceed the first threshold; and
providing the identified second set of data records according to the second reporting format when the size of the second set of data records exceeds the first threshold but does not exceed the second threshold.

9. A method as defined in claim 8 wherein the first reporting format comprises a hypertext markup language (HTML) format for presenting the provided second set of data records in a web browser, and the second reporting format comprises one of: (1) a fixed length text format for presenting the provided second set of data records in a web browser or (2) a tab delimited text format supporting file downloading of the provided second set of data records.

10. A method as defined in claim 8 further comprising not providing the identified second set of data records when the size of the second set of data records exceeds the second threshold.

11. An article of manufacture storing machine readable instructions which, when executed, cause a machine to:
access a profile associated with a reporting query configured to perform record reporting associated with a database comprising a plurality of data records, the profile comprising a first threshold associated with a first reporting format and a second threshold associated with a second reporting format;
query the database to identify a set of data records satisfying search criteria included in the reporting query
provide the identified set of data records according to the first reporting format when a size of the set of data records does not exceed the first threshold; and
provide the identified set of data records according to the second reporting format when the size of the set of data records exceeds the first threshold but does not exceed the second threshold.

12. An article of manufacture as defined in claim 11 wherein the first reporting format comprises a hypertext markup language (HTML) format for presenting the provided set of data records in a web browser, and the second reporting format comprises one of: (1) a fixed length text format for presenting the provided set of data records in a web browser or (2) a tab delimited text format supporting file downloading of the provided set of data records.

13. An article of manufacture as defined in claim 11 wherein the machine readable instructions, when executed, further cause the machine to not provide the identified set of data records when the size of the second set of data records exceeds the second threshold.

14. An article of manufacture as defined in claim 11 wherein the reporting query is a first reporting query in a plurality of reporting queries, the first reporting query is designated as a detailed reporting query, and wherein the machine readable instructions, when executed, further cause the machine to:
access the profile in response to invocation of a second reporting query including the search criteria that is also included in the first reporting query, the second reporting query designated as a summary reporting query; and
provide a number of data records expected to satisfy the search criteria included in the second reporting query if the search criteria were used to query the database, the number of data records to be presented in a first manner when the number of data records does not exceed the first threshold, and the number of data records to be presented in a second manner when the number of data records exceeds the first threshold but does not exceed the second threshold.

15. An article of manufacture as defined in claim 14 wherein the first manner to present the number of data records comprises at least one of a first color or a first font, and wherein the second manner to present the number of data records comprises at least one of a second color or a second font.

16. An article of manufacture as defined in claim 14 wherein the machine readable instructions, when executed, further cause the machine to:
pre-calculate the number of data records expected to satisfy the search criteria included in the second reporting query prior to the invocation of the second reporting query; and
provide the number of data records in response to the invocation of the second reporting query without querying the database.

17. An apparatus to perform record reporting associated with a database comprising a plurality of data records, the apparatus comprising:
a reporting pre-calculator to pre-calculate first summary data and a first number of data records expected to be returned for a first reporting query in a plurality of possible reporting queries, the first reporting query designated as a summary reporting query, the first summary data determined from a first set of data records obtained in response to querying the database based on first search criteria included in the first reporting query; and
a report generator to:
provide the first reporting data and the first number of data records in response to an invocation of the first reporting query, the first reporting data and the first number of data records to be provided without querying the database; and
query the database to identify and provide a second set of data records satisfying the first search criteria in response to an invocation of a second reporting query, the second reporting query designated as a detailed reporting query, the report generator to provide the second set of data according to a first reporting format when a size of the second set of data records does not exceed a first threshold and according to a second reporting format when the size of the second set of data records exceeds the first threshold but does not exceed the second threshold.

18. An apparatus as defined in claim 17 further comprising a reporting hierarchy manager to configure the plurality of possible reporting queries to form a reporting path hierarchy and to designate each of the plurality of possible reporting queries as either a summary reporting query or a detailed reporting query, wherein a third reporting query and a fourth reporting query at a lower level than the third reporting query are included in a reporting path when the third and fourth reporting queries include common search criteria and the fourth reporting query includes one or more additional search criteria.

19. An apparatus as defined in claim 17 wherein the reporting pre-calculator further operates to:
determine when a pre-calculation interval has expired after pre-calculating the first summary data and the first number of data records;
pre-calculate second summary data and a second number of data records expected to be returned for the first reporting query after the pre-calculation interval is determined to have expired, the second summary data determined from a third set of data records obtained in response to querying the database based on the first search criteria included in the first reporting query; and
replace the first summary data and the first number of data records with the respective second summary data and the second number of data records.

20. An apparatus as defined in claim 17 further comprising a profile manager to specify a set of profiles and to associate a profile with one or more of the plurality of possible reporting queries, the profile comprising a structured query language (SQL) clause template to be populated by at least some search criteria included in the one or more of the plurality of possible reporting queries associated with the profile, the profile further comprising a plurality of thresholds associated with a respective plurality of reporting formats.
